(19) United States
(12) Patent Application Publication
(10) Pub. No.: US 2023/0173672 A1
(43) Pub. Date: Jun. 8, 2023

(54) SMART HAND TOOLS WITH SENSING AND WIRELESS CAPABILITIES, AND SYSTEMS AND METHODS FOR USING SAME

(71) Applicant: CommScope Technologies LLC, Hickory, NC (US)

(72) Inventors: Thomas G. SHEEHE, Allen, TX (US); Troy I. VANDERHOOF, Prosper, TX (US)

(21) Appl. No.: 17/997,785

(22) PCT Filed: May 24, 2021
(86) PCT No.: PCT/US2021/033887

§ 371 Date: Nov. 2, 2022

Related U.S. Application Data
(60) Provisional application No. 63/033,652, filed on Jun. 2, 2020.

(51) Int. Cl. B25J 9/16; B25J 13/08

(52) U.S. Cl. CPC B25J 9/1656; B25J 13/085; B25J 9/161

(57) ABSTRACT

A smart hand tool includes a tool body having a distal working end and an opposite handle end configured to be gripped by a user, at least one sensor coupled to the tool body, and a wireless transmitter in communication with the at least one sensor and configured to transmit information from the at least one sensor to a remote device. The at least one sensor is configured to measure one or more physical parameters when the hand tool is in use, such as movement of the tool body working end, rotation of the tool body working end, torque at the tool body working end, pressure at the tool body working end, and temperature at the tool body working end.

### CROSS-REFERENCE TO RELATED APPLICATION

The present application claims priority to U.S. Provisional Patent Application Ser. No. 63/033,652, filed Jun. 2, 2020, the entire content of which is incorporated herein by reference.

### FIELD

The present invention relates generally to tools and, more particularly, to hand tools.

### BACKGROUND

Hand tools are widely used in factories during the assembly of products. Unfortunately, ensuring proper usage by operators during assembly may be challenging. In addition, many hand tools are unable to measure position, movement, rotation, etc. Thus, potentially valuable data may be lost during use. As a result, verifying that product assembly has been performed correctly may often be a required additional step in manufacturing processes involving hand tools, and this requires human and/or machine resources, which may add to the cost and complexity of the manufacturing process.

### SUMMARY

According to some embodiments of the present invention, a smart hand tool includes a tool body having a distal working end and an opposite handle end configured to be gripped by a user, at least one sensor coupled to the tool body, and a wireless transmitter in communication with the at least one sensor and configured to transmit information from the at least one sensor to a remote device, such as a computer. The at least one sensor is configured to measure one or more physical parameters when the hand tool is in use, such as, for example, movement of the tool body working end, rotation of the tool body working end, orientation of the tool body working end, torque at the tool body working end, pressure at the tool body working end, temperature at the tool body working end, etc. Exemplary hand tools may include, but are not limited to, screwdrivers, hex keys, wrenches, soldering irons, crimping tools, etc.

Exemplary sensors that may be utilized include, but are not limited to, orientation sensors, accelerometers, gyroscopes, torque sensors, pressure sensors, magnetometers, image sensors, temperature sensors, etc. In some embodiments, the at least one sensor is configured to measure movement, rotation and/or orientation of the tool body working end relative to an x, y, z coordinate system.

In some embodiments, the tool body working end is configured to engage a fastener head of each of a plurality of threaded fasteners for rotation thereof. A user utilizes the hand tool to install the plurality of threaded fasteners according to an installation procedure, and the at least one sensor is configured to measure one or more of the following during the installation procedure: movement of the tool body working end from one threaded fastener to another threaded fastener, rotation of the tool body working end as each threaded fastener is installed, torque associated with rotation of the tool body working end as each threaded fastener is installed, and pressure on the tool body working end as each threaded fastener is installed.

In some embodiments, the tool body working end is configured to engage a screw head of each of a plurality of tuning screws of a telecommunication base station cavity filter. A user utilizes the hand tool to adjustably rotate the plurality of tuning screws according to a frequency tuning procedure, and the at least one sensor is configured to measure one or more of the following during the frequency tuning procedure: movement of the tool body working end from one tuning screw to another tuning screw, rotation of the tool body working end as each tuning screw is adjusted, torque associated with rotation of the tool body working end as each tuning screw is adjusted, and pressure on the tool body working end as each tuning screw is adjusted.

According to other embodiments, a system includes a smart hand tool wirelessly connected to a computer. The hand tool has a tool body with a distal working end and an opposite handle end configured to be gripped by a user, at least one sensor coupled to the tool body, and a wireless transmitter. The at least one sensor is configured to measure one or more physical parameters when the hand tool is used to perform a task having a sequence of operations, such as movement of the tool body working end, rotation of the tool body working end, torque at the tool body working end, pressure at the tool body working end, temperature at the tool body working end, etc. Exemplary hand tools may include, but are not limited to, screwdrivers, hex keys, wrenches, soldering irons, crimping tools, etc. Exemplary sensors that may be utilized include, but are not limited to, accelerometers, gyroscopes, torque sensors, pressure sensors, magnetometers, image sensors, temperature sensors, etc. In some embodiments, the at least one sensor is configured to measure movement, rotation and/or orientation of the tool body working end relative to an x, y, z coordinate system.

The wireless transmitter is in communication with the at least one sensor and is configured to transmit information from the at least one sensor to the computer. The computer includes data storage for storing the received information. The computer includes a processor that is configured to generate a digital map of the performing of the task using the stored information. The digital map includes instructions that can be utilized by a robot to perform the sequence of operations of the task and/or to perform an inspection.

According to other embodiments, a system includes a smart hand tool wirelessly connected to a computer. The hand tool has a tool body with a distal working end and an opposite handle end configured to be gripped by a user, at least one sensor coupled to the tool body, and a wireless transmitter. The tool body working end is configured to engage a fastener head of each of a plurality of threaded fasteners for rotation thereof, and the at least one sensor is configured to measure one or more of the following during installation of the plurality of threaded fasteners: movement of the tool body working end from one threaded fastener to another threaded fastener, rotation of the tool body working end as each threaded fastener is installed, torque associated with rotation of the tool body working end as each threaded fastener is installed, and pressure on the tool body working end as each threaded fastener is installed. Exemplary hand tools may include, but are not limited to, screwdrivers, hex keys, and wrenches. Exemplary sensors that may be utilized include, but are not limited to, accelerometers, gyroscopes, torque sensors, pressure sensors, etc. In some embodiments, the at least one sensor is configured to measure movement, rotation and/or orientation of the tool body working end relative to an x, y, z coordinate system.

The computer includes data storage that stores the information from the at least one sensor during the installation of the plurality of threaded fasteners. The computer includes a processor that is configured to generate a digital map of the installation of the threaded fasteners using the stored information. The digital map includes instructions that can be utilized by a robot to perform the installation of the plurality of threaded fasteners and/or to perform an inspection of the installation.

According to other embodiments, a system includes a smart hand tool wirelessly connected to a computer. The hand tool has a tool body with a distal working end and an opposite handle end configured to be gripped by a user, at least one sensor coupled to the tool body, and a wireless transmitter. The tool body working end is configured to engage a screw head of each of a plurality of tuning screws of a telecommunication base station cavity filter, and the at least one sensor is configured to measure one or more of the following during frequency tuning of the cavity filter: movement of the tool body working end from one tuning screw to another tuning screw, rotation of the tool body working end as each tuning screw is adjusted, torque associated with rotation of the tool body working end as each tuning screw is adjusted, and pressure on the tool body working end as each tuning screw is rotatably adjusted. Exemplary hand tools may include, but are not limited to, screwdrivers, hex keys, wrenches, etc. Exemplary sensors that may be utilized include, but are not limited to, accelerometers, gyroscopes, torque sensors, pressure sensors, etc. In some embodiments, the at least one sensor is configured to measure movement, rotation and/or orientation of the tool body working end relative to an x, y, z coordinate system.

The computer includes data storage that stores the information from the at least one sensor during the frequency tuning of the cavity filter. The computer includes a processor that is configured to generate a digital map of the frequency tuning of the cavity filter using the stored information. The digital map includes instructions that can be utilized by a robot to perform the frequency tuning of the cavity filter.

According to other embodiments, a method of automating a manual task having a sequence of operations includes using a smart hand tool to perform the manual task. The hand tool includes a tool body having a distal working end, and at least one sensor coupled to the tool body and configured to measure one or more physical parameters during performance of the task, such as movement of the tool body working end, rotation of the tool body working end, torque at the tool body working end, pressure at the tool body working end, and temperature at the tool body working end. Information from the at least one sensor is wirelessly transmitted during the task to data storage via a wireless transmitter in communication with the at least one sensor and stored. A processor generates a digital map of the performing of the task using the stored information. The digital map includes instructions that can be utilized by a robot to perform the sequence of operations of the task.

Exemplary hand tools may include, but are not limited to, screwdrivers, hex keys, wrenches, soldering irons, crimping tools, etc. Exemplary sensors that may be utilized include, but are not limited to, accelerometers, gyroscopes, torque sensors, pressure sensors, temperature sensors, etc. In some embodiments, the at least one sensor is configured to measure movement, rotation and/or orientation of the tool body working end relative to an x, y, z coordinate system.

Adding sensing and wireless capabilities to hand tools according to embodiments of the present invention provides the ability to check an assembly process in real time and to ensure that all assembly steps are performed properly. Furthermore, manufacturers can use the information acquired to build a digital map containing instructions that can be used for robotic inspection and assembly. For example, during the initial build of a new product, smart band tools according to embodiments of the present invention can be used to measure where fasteners are installed and this information can be stored in a database and then used to drive a robotic arm which can pinpoint those locations and capture images of the fasteners. This information can then be fed into a machine vision training library to train an automatic inspection station where to inspect and what the installed fasteners look like. When a product is in mass production, this automated inspection can be performed without requiring reprogramming and training. In addition, information acquired from smart hand tools can be used for other applications, such as trending and optimization.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally tiled claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 is a schematic illustration of a smart hand tool, according to some embodiments of the present invention.

FIG. 2 is a schematic illustration of a sensor device associated with the smart hand tool of FIG. 1, according to some embodiments.

FIG. 3 illustrates the smart hand tool of FIG. 1 in wireless communication with a remote device, according to some embodiments.

FIG. 4 illustrates a product having a plurality of threaded fasteners, and a sequence in which the smart hand tool of FIG. 1 is used to install the plurality of fasteners.

FIG. 5 is a partial perspective view of a resonant cavity filter having a plurality of tuning screws that the smart hand tool of FIG. 1 is used to adjustably rotate in order to tune the cavity filter.

FIG. 6 is a block diagram that illustrates details of an exemplary processor and memory that may be used to create a digital map, according to some embodiments.

FIG. 7 is a flowchart that illustrates exemplary operations for performing a task with the smart hand tool of FIG. 1 and generating a digital map of the task performed, according to some embodiments.

### DETAILED DESCRIPTION

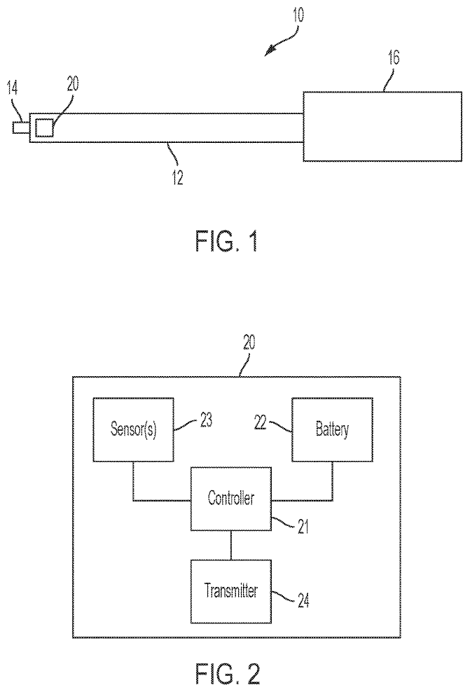

Referring initially to FIGS. 1-2, a smart hand tool 10, according to some embodiments of the present invention, is illustrated. The smart hand tool 10 includes a tool body 12 having a distal working end 14 and an opposite handle end 16 configured to be gripped by a user. The smart hand tool 10 may be any of various types of hand tools including, but not limited to, screwdrivers, hex keys, wrenches, soldering irons, crimping tools, etc. In operation, a user grips the smart hand tool 10 at the handle end 16 and uses the working end 14 to engage a workpiece, such as a screw, a bolt, a nut, another type of fastener, solder a connection, crimp a cable, etc.

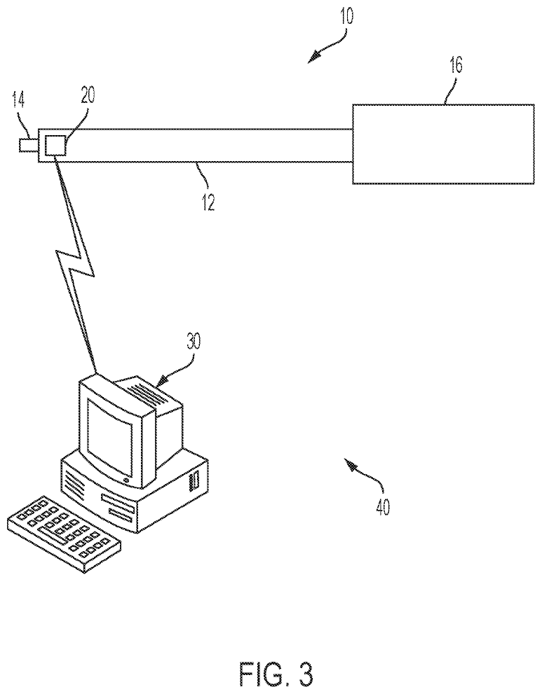

The smart hand tool 10 includes a sensor device 20 that is configured to sense one or more physical parameters at the working end 14 and transmit the sensed information to a remote device 30 (FIG. 3), such as a computer. The sensor device 20 may be attached to or otherwise incorporated within the tool body 12 at or near the working end 14. In the illustrated embodiment, the sensor device 20 includes a controller 21, a power source, such as a battery 22, one or more sensors 23, and a wireless transmitter 24. The battery 22 supplies power to the various components of the sensor device 20. The battery 22 may be, for example, a lithium polymer battery or other battery that is sufficiently small to fit within the sensor device 20. In some embodiments, the battery 22 may be charged via a charge port, such as a USB charge port. The controller 21 controls operation of the sensor(s) 23 and also controls the transmitter 24 which is configured to wirelessly transmit information from the sensor(s) 23 to the remote device 30.

Exemplary sensors 23 that may be utilized include, but are not limited to, orientation sensors, accelerometers, gyroscopes, torque sensors, pressure sensors, temperature sensors, magnetometers, image sensors, etc. An exemplary accelerometer may be configured to measure movement and rotation of the tool body working end 14 relative to an x, y, z coordinate system. For example, in some embodiments, sensor(s) 23 may be utilized to measure one or more of the following when the hand tool 10 is in use: movement of the tool body working end 14, rotation of the tool body working end 14, torque at the tool body working end 14, pressure at the tool body working end 14, temperature at the tool body working end 14, etc.

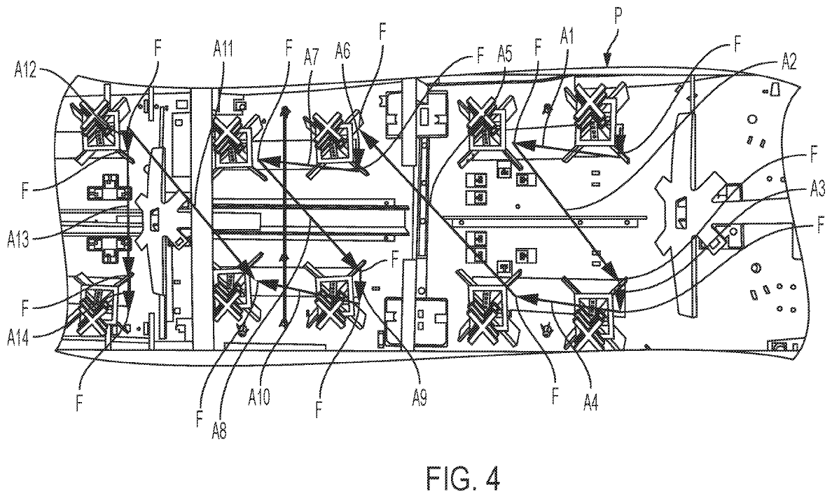

In one example, the smart hand tool 10 is utilized to assemble a product P (FIG. 4) having a plurality of threaded fasteners F in various locations. The tool body working end 14 is configured to engage a fastener head of each of the threaded fasteners F for rotation thereof. A user utilizes the smart hand tool 10 to threadingly install the fasteners F according to an installation procedure, as indicated by the arrows A₁-A₁₄ in FIG. 4. The smart hand tool 10 includes at least one sensor 23 configured to measure one or more of the following during the installation procedure: movement of the tool body working end 14 from one threaded fastener F to another threaded fastener F, rotation of the tool body working end 14 as each threaded fastener F is installed, torque associated with rotation of the tool body working end 14 as each threaded fastener F is installed, and pressure on the tool body working end 14 as each threaded fastener F is installed.

In some embodiments, the smart hand tool 10 may be used to install and/or to adjust items on a plurality of products P, and can obtain and store information regarding how the smart hand tool 10 was used on each product P. For example, when the smart hand tool 10 is used to install fasteners F on the product P of FIG. 4, the smart hand tool 10 may record how the smart hand tool 10 was moved while installing the fasteners F, the locations where the smart hand tool 10 was activated to rotate in order to install a fastener F, the amount of torque applied, etc. The smart hand tool 10 may record this information for each of a plurality of additional instances of the product P, and may then process by, for example, filtering and/or averaging the recorded information. This may improve the accuracy of the recorded information.

The processed information may then be used to train a robotic machine that has a machine vision system. For example, the information regarding how the smart hand tool 10 was moved while installing the fasteners F on the series of products P may be downloaded into a processor that is used to control the robotic machine. This information may be used to program the robotic machine to automatically install the fasteners F, as the information obtained by the smart hand tool 10 may be the same information that a robotic machine requires to use a robotic arm to automatically install the fasteners F on the product P. The machine vision system of the robotic machine may also be programmed to recognize the locations where the fasteners F are installed (e.g., by downloading images of each location where a fastener F is to be installed) and may use this information to correct for any small inaccuracies in the information provided by the smart hand tool 10. In some embodiments, the smart hand tool 10 may include a camera that is used to capture the images that are used by the machine vision system.

Robotic machines may reduce the cost of manufacturing, and may often increase consistency and accuracy in the assembly process. Unfortunately, however, it may be time-consuming to program robotic machines, which can reduce their cost advantage and may even make them economically impractical for use in manufacturing some products. By using the smart hand tool 10 to automatically perform much of the programming of the robotic machine, the cost of programming such robotic machines may be significantly reduced.

The smart hand tools 10 according to embodiments of the present invention may also be used to inspect assembled products to make sure that they were assembled correctly. For example, using the product P of FIG. 4 as an example, conventionally a robotic inspection machine may be used after assembly to confirm that all of the fasteners F were properly installed. However, the information gathered by the smart hand tool 10 may be used to confirm that each fastener F was installed properly. As such, the smart hand tool 10 may be used to perform the robotic inspection during the installation process and may eliminate the need for a post-installation robotic inspection.

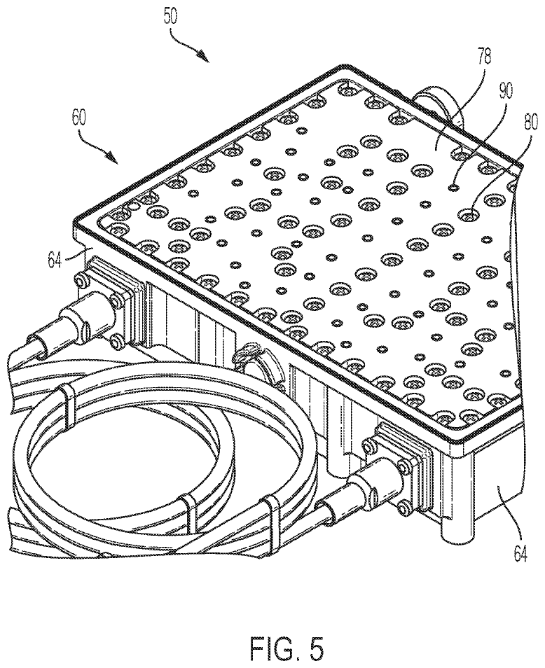

In another example, the smart hand tool 10 is utilized to tune a telecommunication base station cavity filter, as illustrated in FIG. 5. The illustrated cavity filter 50 includes a housing 60 having a floor (not shown) and a plurality of sidewalls 64. A plurality of internal walls (not shown) extend upwardly from the floor to divide the interior of the housing 60 into a plurality of cavities. A plurality of resonating elements are mounted within the cavities, and the resonating elements may comprise, for example, dielectric resonators or coaxial metal resonators, and may be mounted by screws 80 onto selected ones of the internally threaded cavities. A cover plate 78 acts as a top cover for the cavity filter 50. A plurality of tuning screws 90 are also provided. These tuning screws 90 may be rotatably adjusted to tune aspects of the frequency response of the cavity filter 50. The tool body working end 14 is configured to engage a screw head of each of the plurality of tuning screws 90 for rotation thereof.

A user utilizes the smart hand tool 10 to rotatably adjust the plurality of tuning screws according to a frequency tuning procedure. The smart hand tool 10 includes at least one sensor 23 configured to measure one or more of the following during the frequency tuning procedure: movement of the tool body working end 14 from one tuning screw 90 to another tuning screw 90, rotation of the tool body working end 14 as each tuning screw 90 is adjusted, torque associated with rotation of the tool body working end 14 as each tuning screw 90 is adjusted, and pressure on the tool body working end 14 as each tuning screw 90 is adjusted. As such, the smart hand tool 10 can obtain and store information about how much each tuning screw 90 was turned, and in which direction, as well as information about the sequence in which each tuning screw 90 was adjusted. This information can then be used to produce instructions for training a robot to perform the frequency tuning procedure.

In other embodiments, the smart hand tool 10 is a soldering iron and the sensor device 20 includes a temperature sensor 23. The temperature sensor 23 is configured to determine the temperature of a surface of a workpiece as a result of the working end 14 of the soldering iron 10 touching the surface. This may facilitate the determination of a location of a solder joint. In some embodiments the sensor device 20 includes an orientation sensor (e.g., an accelerometer and/or gyroscope) that is capable of determining the orientation of the soldering iron 10 in an x, y, x coordinate system such that the tilt or angle of the soldering iron 10 during the soldering of a joint is known. The soldering iron may be tilted in order to avoid obstructions. Information can be obtained and stored about the orientation of the soldering iron 10 at each soldering location. This information can then be used to train a robot to perform the soldering procedure.

Referring to FIG. 3, a system 40 is illustrated that includes the smart hand tool 10 of FIG. 1 and a device 30, such as a computer, wirelessly connected to the hand tool 10. The device 30 may include or be in communication with data storage that is configured to receive and store information from the sensor(s) 23 of the smart hand tool 10 via the wireless transmitter 24 during performing of a task. The device 30 also includes a processor configured to generate a digital map of a task performed by a user with the smart hand tool 10 using the stored information. The digital map includes instructions that can be utilized by a robot to perform the sequence of operations of the particular task. The digital map may also be utilized by a machine vision system to recognize an image of a product during manufacturing and to know where fasteners and other components are located.

In some embodiments, the device 30 may display a user interface containing a view of a product on which a task is being performed using the smart hand tool 10. For example, during the performance of a task having a sequence of operations, the user interface may display a color (e.g., green) when a location of the tool body working end 14 is in a correct location and/or is near a correct location. In some embodiments, the user interface may be utilized to signal when a correct torque or pressure has been applied to a component via the tool body working end 14. In other embodiments, the smart hand tool 10 may be fitted with a similar user interface or with a vibration device that performs a similar notification function. A vibration at the smart hand tool 10 may be used to signal when a location of the tool body working end 14 is in a correct location and/or is near the correct location. In some embodiments, a vibration may be utilized to signal when a correct torque or pressure has been applied to a component via the tool body working end 14.

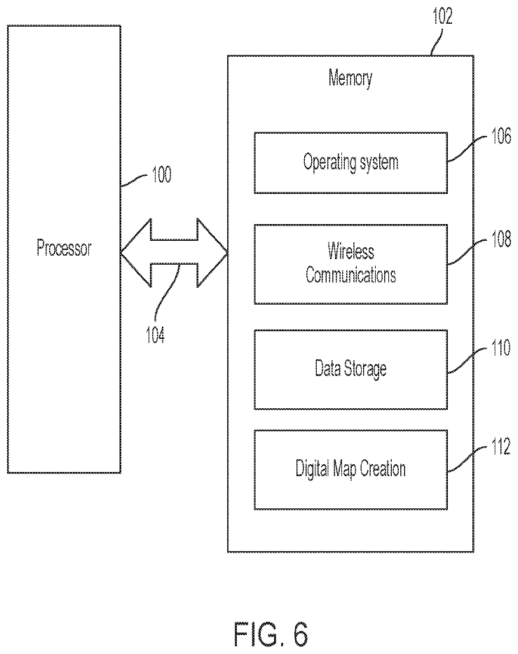

FIG. 6 illustrates an exemplary processor 100 and memory 102 that may be used to create a digital map of a manually performed task, according to some embodiments. The processor 100 communicates with the memory 102 via an address/data bus 104. The processor 100 may be, for example, a commercially available or custom microprocessor. The memory 102 is representative of the overall hierarchy of memory devices containing the software and data used to create a digital map of a sequence of manufacturing operations as described herein, in accordance with some embodiments. The memory 102 may include, but is not limited to, the following types of devices: cache, ROM, PROM, EPROM, EEPROM, flash, SRAM, and DRAM.

As shown in FIG. 6, the memory 102 may hold various categories of software and data: an operating system 106, a wireless communications module 108, a data storage module 110, and a digital map creation module 112. The operating system 106 controls operations of the device 30. In particular, the operating system 106 may manage the resources of the device 30 and may coordinate execution of various programs (e.g., the wireless communications module 108, the data storage module 110, the digital map creation module 112, etc.) by the processor 100. The wireless communications module 108 comprises logic for communicating with the smart hand tool 10 via the transmitter 24 and storing data received from the one or more sensors 23 of the smart hand tool 10 in data storage 110. The digital map creation module 112 comprises logic for generating a digital map of a task performed by a user with the smart hand tool 10 using the stored information.

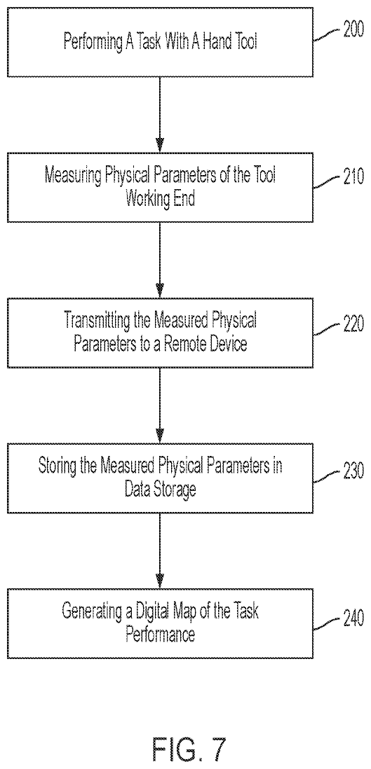

Referring to FIG. 7, a method of automating a manual task performed with the smart hand tool 10 of FIG. 1, according to some embodiments, is illustrated. The hand tool 10 is used to perform a task having a sequence of operations (Block 200). Sensor(s) 23 coupled to the hand tool are configured to measure one or more physical parameters at the working end 14 of the hand tool 10 during the task (Block 210). Information from the smart hand tool sensor(s) 23 is wirelessly transmitted during the task to the device 30 via the wireless transmitter 24 and stored in data storage 110 (Block 230). A digital map is then generated of the sequence of operations of the task using the stored information (Block 240). The digital map includes instructions that can be utilized by a robot to perform the sequence of operations of the task and/or to inspect a product.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A hand tool, comprising:
a tool body comprising a distal working end and an opposite handle end;
at least one sensor coupled to the tool body and configured to measure at least one physical parameter at the working end when the hand tool is in use; and
a wireless transmitter in communication with the at least one sensor and configured to transmit information from the at least one sensor to a remote device.

2. The hand tool of claim 1, wherein the at least one physical parameter includes one or more of the following: movement of the tool body working end, rotation of the tool body working end, orientation of the tool body working end, torque at the tool body working end, pressure at the tool body working end, and temperature at the tool body working end.

3. The hand tool of claim 1, wherein the at least one sensor comprises one or more of the following: an accelerometer, a gyroscope, a torque sensor, a pressure sensor, a magnetometer, an image sensor, and a temperature sensor.

4. The hand tool of claim 1, wherein the at least one sensor is configured to measure movement, rotation and/or orientation of the tool body working end relative to an x, y, z coordinate system.

5. The hand tool of claim 1, wherein the hand tool is a screwdriver, a hex key, a wrench, a soldering iron, or a crimping tool.

6. The hand tool of claim 1, wherein the tool body working end is configured to engage a fastener head of each of a plurality of threaded fasteners for rotation thereof, wherein a user utilizes the hand tool to install the plurality of threaded fasteners according to an installation procedure, and wherein the at least one sensor is configured to measure one or more of the following during the installation procedure: movement of the tool body working end from one threaded fastener to another threaded fastener, rotation of the tool body working end as each threaded fastener is installed, torque associated with rotation of the tool body working end as each threaded fastener is installed, and pressure on the tool body working end as each threaded fastener is installed.

7. The hand tool of claim 1, wherein the tool body working end is configured to engage a screw head of each of a plurality of tuning screws of a telecommunication base station cavity filter, wherein a user utilizes the hand tool to adjustably rotate the plurality of tuning screws according to a frequency tuning procedure, and wherein the at least one sensor is configured to measure one or more of the following during the frequency tuning procedure: movement of the tool body working end from one tuning screw to another tuning screw, rotation of the tool body working end as each tuning screw is adjusted, torque associated with rotation of the tool body working end as each tuning screw is adjusted, and pressure on the tool body working end as each tuning screw is adjusted.

8. A system, comprising:
a hand tool, comprising:
a tool body comprising a distal working end and an opposite handle end;
at least one sensor coupled to the tool body and configured to measure one or more physical parameters when the hand tool is used to perform a task having a sequence of operations; and
a wireless transmitter in communication with the at least one sensor; and a computer, comprising:
data storage configured to receive and store information from the at least one sensor via the wireless transmitter during performing of the task; and
a processor configured to generate a digital map of the performing of the task using the stored information, wherein the digital map comprises instructions that can be utilized by a robot to perform the sequence of operations of the task.

9. The system of claim 8, wherein the at least one physical parameter includes one or more of the following: movement of the tool body working end, rotation of the tool body working end, orientation of the tool body working end, torque at the tool body working end, pressure at the tool body working end, and temperature at the tool body working end.

10. The system of claim 8, wherein the at least one sensor comprises one or more of the following: an accelerometer, a torque sensor, a pressure sensor, a magnetometer, an image sensor, and a temperature sensor.

11. The system of claim 8, wherein the at least one sensor is configured to measure movement, rotation and/or orientation of the tool body working end relative to an x, y, z coordinate system.

12. The system of claim 8, wherein the hand tool is a screwdriver, a hex key, a wrench, a soldering iron, or a crimping tool.

13-20. (canceled)

21. A method of automating a manual task having a sequence of operations, the method comprising:
using a hand tool to perform the manual task, wherein the hand tool comprises a tool body having a distal working end, and at least one sensor coupled to the tool body
measuring, via the at least one sensor, one or more of the following during the task: movement of the tool body working end, rotation of the tool body working end, torque at the tool body working end, pressure at the tool body working end, and temperature at the tool body working end;
wirelessly transmitting information from the at least one sensor during the task to data storage via a wireless transmitter in communication with the at least one sensor;
storing the information in the data storage; and
generating, via a processor, a digital map of the performing of the task using the stored information, wherein the digital map comprises instructions that can be utilized by a robot to perform the sequence of operations of the task.

22. The method of claim 21, wherein the at least one sensor comprises one or more of the following: an accelerometer, gyroscope, a torque sensor, a pressure sensor, a magnetometer, an image sensor and a temperature sensor.

23. The method of claim 21, wherein the at least one sensor is configured to measure movement, rotation and/or orientation of the tool body working end relative to an x, y, z coordinate system.

24. The method of claim 21, wherein the hand tool is a screwdriver, a hex key, a wrench, a soldering iron, or a crimping tool.

25. The method of claim 21, wherein the tool body working end is configured to engage a fastener head of each of a plurality of threaded fasteners for rotation thereof, and wherein the method further comprises:
installing the plurality of threaded fasteners via the hand tool according to an installation procedure; and
wherein the measuring step comprises measuring one or more of the following during the installation procedure: movement of the tool body working end from one threaded fastener to another threaded fastener, rotation of the tool body working end as each threaded fastener is installed, torque associated with rotation of the tool body working end as each threaded fastener is installed, and pressure on the tool body working end as each threaded fastener is installed.

26. The method of claim 21, wherein the tool body working end is configured to engage a screw head of each of a plurality of tuning screws of a telecommunication base station cavity filter, and wherein the method further comprises:
adjustably rotating the plurality of tuning screws via the hand tool according to a frequency tuning procedure; and
wherein the measuring step comprises measuring one or more of the following during the frequency tuning procedure: movement of the tool body working end from one tuning screw to another tuning screw, rotation of the tool body working end as each tuning screw is adjusted, torque associated with rotation of the tool body working end as each tuning screw is adjusted, and pressure on the tool body working end as each tuning screw is adjusted.
